(19) United States
(12) Patent Application Publication
(10) Pub. No.: US 2009/0313318 A1
(43) Pub. Date: Dec. 17, 2009

(54) System and method using interpretation filters for commercial data insertion into mobile computing devices

(76) Inventors: Thomas A. Dye, Austin, TX (US); Eric A. Tanner, Austin, TX (US)

Correspondence Address: Thomas A. Dye, 6621 Candle ridge Covet, Austin, TX, 78731, US

(21) Appl. No.: 12/456,073

(22) Filed: Jun. 11, 2009

Related U.S. Application Data
(60) Provisional application No. 61/131,987, filed on Jun. 13, 2008.

(51) Int. Cl. G06F 15/16

(52) U.S. Cl. 709/202; 709/246; 709/219

(57) ABSTRACT

The present invention teaches a method to alter browser programming responses by the substitution of certain client-server communications commands allowing certain browser requests to be redirected to alternate servers for further interpretation and subsequent server responses. The purpose of this method is injection of custom content into browser-based device displays without disruption of the original page content. This method accomplishes the task without requiring additional plug-in applications, browser or client device code modifications. The invention teaches the use of a local proxy server or embedded device but also claims the use of remote network proxy servers to transparently alter the command request sequence of the client browser in order to request alternate information other than that normally requested by the browser for interpretation and display. The present invention also teaches how to identify web publishers or domain owners for registration notification and possible financial compensation.

### CROSS-REFERENCE TO RELATED APPLICATIONS

This application is the formal U.S. patent application based on a previous provisional application No. #61/131987 filed on Jun. 13, 2008, entitled “SYSTEM AND METHOD USING INTERPRETATION FILTERS FOR COMMERCIAL DATA INSERTION INTO CLIENT COMPUTING DEVICES” whose inventors are Thomas A. Dye et al, Austin, Tex. USA; and utility patent application Ser. No. 11/354,604, filed on Feb. 15, 2006, entitled “SYSTEM AND METHOD FOR DATA INSERTION INTO PASSIVEY MONITORED NETWORK EVENTS” whose inventor is Dye et al, of Austin, Tex. USA; being incorporated herein by reference for all intents and purposes.

This application is also related to the following co-pending U.S. Provisional Patent Applications, which has a common assignee and at least one common inventor, and which are herein incorporated by reference in entirety for all intents and purposes:

| SERIAL | DOCKET | |
|---|---|---|
| NUMBER | NUMBER | TITLE |
| 60/773441 | 66245-002 | Mixed Mode Business Method for |
| | | passively inserting commercial |
| | | branding information during network |
| | | event transactions (filed Feb. 16, 2006 |
| | | ABANDON) |
| 61/131988 | 66276-005 | Business method and process for |
| | | commercial establishments to |
| | | advertise directly into proprietary |
| | | closed circuit networks (filed |
| | | Jun. 13, 2008) |
| 61/137011 | 66285-007 | System and method for passive |
| | | manipulation of data insertion into |
| | | client computing devices (filed |
| | | Jul. 25, 2008) |

### BACKGROUND OF THE INVENTION

1. Field of the Invention

The present invention relates to the field of computer, software and network systems, and more particularly the use of a client/server communications network model to deliver new and/or additional content to Mobile computing and communications devices. Alternate environments of the present invention are based on delivery of previously downloaded content or specific application software embedded within the mobile device. The field of this invention pertains to specific operation of wireless or wired networks that deliver dynamically selected objects into browser applications running on Mobile computing and other communication devices typically located at the networks edge. The present invention allows alternate (typically local) advertisers to advertise products and/or services by proxy recognition and filtering of third party advertising URL addresses on out-bound requests from one or more client browser applications and upon said recognition substitution of a replacement URL address using firewall techniques to block the third party web-server requests from ever entering the Wide Area Network (WAN) domain. The system and method of the present invention in the preferred embodiment substitutes an alternate URL request address along with additional information (tokens) to request alternate information from an alternate web-server for the eventual display by the browser client. Display of the alternate web-server information is preferably rendered by the client browser application to the same region of the browser display with the same image resolution as the original “blocked” image request. Alternate embodiments of the present invention may use a recognition and replacement algorithm that monitors and then modifies the browsers incoming HTTP stream changing the original URL requested address with an alternate URL address and tokens. The present invention preferably uses a device (proxy server) located at the WAN network edge within the local premises, broadcast area or establishment. In alternate embodiments the proxy server may be located off the network edge at the Internet back-bone or in a data-center where the same recognition and substitution process is carried out local device proxies all HTTP port 80 data to the remote proxy for URL and token substitution. Thus, URL substitution along with additional informational tokens push browser requests to an alternate ad network server and said tokens carry information about how alternate content and data are represented within one or more client(s) browser display window. The preferred embodiment of the present invention is intended to teach one skilled in the art how to apply the present invention into Mobile wireless or wired computing and communications devices such as PDA's, Cell phones, notebook computers and various other computing devices.

2. Description of Prior Art

Prior art as outlined in previous disclosures such as utility patent application Ser. No. 11/354,604, whose inventor is Dye et al, of Austin, Tex. USA taught methods used to embed third party messages into emails as signature lines wherein injection of said messages was accomplished with an external networking device that connects at the wide area network edge.

Provisional disclosure 60/773441 whose inventor is also Dye et al, teaches the business method to overlay third party commercial ads directly into browsers that are served from a remote ad server. This prior art shows how multiple independent companies can work as affiliates to create a revenue stream based on a novel local advertising and hotspot-broadcasting scheme.

Thus, implementation of a novel advertising method that allows dynamic ad objects to be served from an alternate third party server upon the request of the mobile computing devices Internet browser software without altering the browser or client computing devices software is highly sought in order to open new markets making various Internet content freely available to mobile device users.

3. Description of the Related Art

Multiple commercial companies are now engaged in placing advertisements into the displays of mobile devices Internet browsers on a National and International implementation. The most understood model is well-known in the prior art and involves the assembly of Internet advertisements onto web-pages whereby web-page authors sell a sub-portion of their web-page space (allocated like electronic billboards) to National Internet advertising firms such as Google (Adsense), Yahoo (Ad Specs), MSN (adCenter), DoubleClick (Advertising Exchange) and other search engine based advertising companies. The technical process of the prior art has been established for years. In such prior art, the mobile or desktop computing client has a resident Internet browser application which interprets the HTTP data stream (typically served from the original web-page Domain server) to retrieve and display ad objects onto the clients display surface. Wherein ad objects are assembled into pre-defined two-dimensional areas of the client's browser display window. The client browser application software is responsible for retrieval of the ad objects from Internet web-servers run by third party ad networks or advertising brokers. The client browser is responsible for interpretation of the HTTP data stream and placement of the ad objects onto the browser window of the end users client device.

In some prior art the proxy server address is hardwired within the router or wireless device such that all the communications are routed through the ISP and directly to one or more third party proxy servers prior to allowing communications directly to the open Internet. Prior art techniques have established the use of remote proxy servers to enable advertising into browser displays via pop-up, pop-under, tool bars, and persistent overlay's that appear every few minutes. These techniques make use of a proxy server located in a remote location wherein, all the HTTP (port 80) data from one or more local establishments is sent to one or more remote proxy servers where the HTML or XML page data is altered or special JavaScript routines are delivered to the browser to allow these various advertising techniques to work. Remote proxy servers have security and speed disadvantages because all the HTTP data from many locations must be funneled remotely into data centers and then to a single point server where the HTML/XML code injection or JavaScript routines are delivered prior to transport to the open internet to finalize the client browsers page requests. Personal privacy is an issue in such prior art methods because all the HTTP information is passed to a third party servers. Businesses and organizations are known to capture and sell private information to advertisers and manufactures allowing them to target individual buying preferences. The prior art method of remote proxy is also a security risk as the majority of the transmitted information is in “clear-text” format and can easily have severe consequences if put in the wrong hands. In alternate embodiments of the prior art proxy systems actually modify the operation of the client software via downloads, plug-ins and software application installs. Such systems are intrusive and can cause miss-operation of client software. Some application that are remotely installed are temporary and will mostly be removed from client computers after the session has ended, although most leave information used for future recognition of certain client configurations and features. Due to typical proxy server data handling, often times all the data from many remote Internet access points is funneled to a single proxy server. In such cases data and communication through-put is may be slow and ineffective. In addition, not only the data transferred to the remote proxy is affected, data that is retrieved from the proxy location is also subject to the same performance issues. In all remote proxy implementations where web-page HTML/XML code is modified by third party ad networks the third party ad network must pay for the additional bandwidth required to receive and transmit the entire HTTP data stream. Since all browser requests must be filtered for page information pertaining to “injection” points all HTTP data must traverse the remote proxy server(s) adding additional costs for bandwidth. It is therefore desirable to eliminate the use of remote proxy servers and client software that points to dedicated remote proxy servers to improve Internet access speed and personal data privacy and security.

The advent of the ability to localize advertising to a known proximity of areas using electronic distribution is a new and novel concept. Most often local advertising has been a subject of conventional advertising such as local print ads in newspapers and yellow page directories, or if on the Internet through ad words or simple text ads. Many of the Internet search firms supply local advertising by using IP addresses that are tied to specific localities usually subdivided by municipalities or groups of zip codes. Such Prior art advertising is does not localize electronic ad placement to business that are in proximity to each other or have a commonality between each other. Thus it is desirable to introduce the technology and process to achieve very specialized focused delivery of advertisements on local proximity model to where potential customers live and shop. In addition, it is desirable to allow manufactures, suppliers and product vendors to advertise directly into businesses with full size images or animations and video directly to the proximity of where supplier's goods and services are sold.

Prior art process for the display of third party internet advertisements onto the display of the end users mobile or computing devices is defined in detail in various papers and practice and for the purpose of this disclosure is assumed known to one knowledgeable in the art. In the method of the prior art web authors publish web-page information by purchase of a Domain name used by DNS servers to name and track the location of a plethora of web-page information. This information is typically hosted (served) by one or more Internet servers. In prior art systems when a client computing device requests access to a specific Domain name the DNS servers resolve the route of the web-page information and forward the requests to servers that send back web-page information to the original client that requested the information. Recently, advertiser brokers have exploited this model by allowing web-page owners (authors) to insert snippets of code into their web pages that allow certain spaces to be used by such advertiser brokers to dynamically insert ad words, 2D images or animations into the space provided by the web-page authors. These brokers monitor the activity of the millions of clients that use Internet browsers through these embedded snippets of code to accomplish the process of serving ads into client browsers based on the “code-snippets” request for object insertion. In return for allowing the ad network providers the web-page ad spaces, payments are made to web-page authors. The snippet of code when interpreted by the browser directs the browser to request access to the advertiser brokers web-server that in-turn retrieves text, images and application data for assembly and insertion by the client browser software for final display onto the client computing device. In such prior art the snippet of code also contains an embedded token which tells the advertiser broker who the web page owner is allowing the advertiser broker to share a portion of the adverting revenue with the web-page owner. Payments to the web-page owner are typically based on Clicks that result in a context switch to the advertisers landing page or web site. In the prior art most of the ad networks have multiple ad network tiers and the plethora of ads requested by the billions of embedded code snippets do not acknowledge information about the exact location or advertising that may be preferential to the point of sale of goods and services. It is therefore desirable to alter the prior art Internet advertising system and method to improve delivery and allow all business to place “in-page” advertising images and animations with the ability to deliver pin-point information, content and branding directly to the proximity of the point of sale. The present invention describes the use of such a novel advertising system and teaches a method as described herein allowing businesses to cost effectively publish in-page internet advertising in the local proximity of the point of sale.

### BRIEF DESCRIPTION OF THE DRAWINGS

The benefits, features, and advantages of the present invention will become better understood with regard to the following description, and accompanying drawings where:

FIG. 1 is a block diagram used by Internet Advertising Network providers to dynamically insert advertisements into one or more client computing devices according to the prior art;

FIG. 2 illustrates the use of a remote proxy server to dynamically inject pop-up or banner advertising to one or more client computers located in one or more Internet access points according to the prior art;

FIG. 3 illustrates an embodiment that uses a proxy server located within the Internet access point to dynamically inject advertisements onto one or more client computers according to the present invention;

FIG. 4a illustrates the preferred embodiment of the local proxy server wherein one or more proxy filters are embedded into a wireless router according to the present invention;

FIG. 4b illustrates an alternate embodiment wherein the local proxy server has multiple network interfaces according to the present invention;

FIG. 4c illustrates another embodiment wherein an local proxy server is connected to an external device to isolate the businesses local area network from the customer wireless network;

FIG. 5a shows a flowchart which illustrates a one possible embodiment using a local proxy server to intercept, filter and modify pertinent data to dynamically place image and data objects into web pages for the purpose of Internet advertising according to the present invention;

FIG. 5b illustrates a coded example for proxy filter and substitution into one of the popular ad network providers according to the present invention.

FIG. 6a illustrates a typical web page prior to application of the present invention;

FIG. 6b illustrates a typical example of one embodiment of the effects of application of the present invention.

FIG. 7 illustrates an alternate embodiment using a remote proxy server to achieve the results seen in FIG. 6b of the present invention.

### DETAILED DESCRIPTION

The following description is presented to enable one of ordinary skill in the art to make and use the present invention as provided within the context of a particular application and its requirements. Various modifications to the preferred embodiment will be apparent to one skilled in the art and the general principles defined herein may be applied to other embodiments. Therefore, the present invention is not intended to be limited to the particular embodiments shown and described herein, but is to be accorded the widest scope consistent with the principles and novel features herein disclosed.

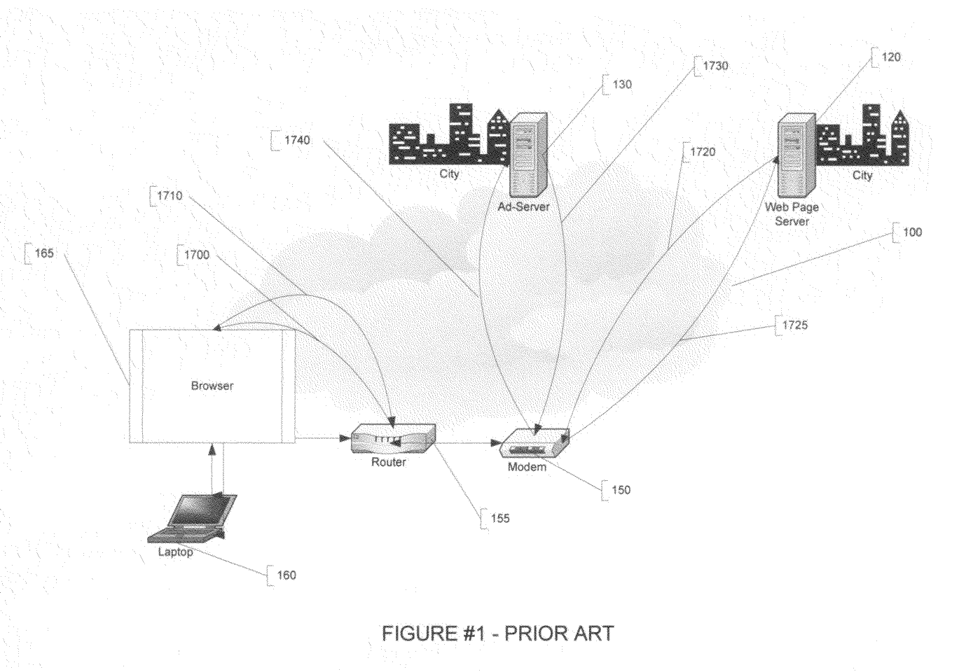

FIG. 1 illustrates one method of the prior art whereby third party advertisement servers 130 (Ad Server) are used to inject HTML & XML data types and images into Web pages that are assembled by client computers 160 using standard browser application software 165. The illustration of FIG. 1 demonstrates the prior art of Internet 100 web page delivery 1720 from one or more Web page servers 120 to one or more data modems 150 connected to the Internet 100. The Data Modem 150 interprets the transmission types and protocols used by broadband carriers and Internet Service Providers (ISPs) as known to one familiar in the art. The Modem 150 in the present embodiment is typically connected to a router 155 used to route a connection to one or more client computers 160. In the preferred embodiment of the present invention the Modem or router have embedded wireless transmitters such that the client computer may receive the connection without physical connection medium such as a CAT5 or CAT6 cable as known in the art. In alternate embodiments the modem or routers may use a physical wired interface to achieve the same type of connection.

In the prior art of FIG. 1 instantiating a web-page request is started by a user action on the client computer 160. This action is typically by input of a Universal Resource Locator (URL) address into one or more browser applications 165 typically in a search window. The URL, if pointing to an external Internet socket, is transmitted 1710 to the router 155 which, determines the next destination path via route table look up and then transferred 155 to the modem 150 for transmission 1725 over a number of route hops to the destination Web-page server 120. The web page server finds the proper directory that contains the original web page content. In this prior art example of FIG. 1, the original web server 120 program code serves one or more HTML, XML JAVA, JavaScript and Flash based application codes and possible additional directives to the computing client browser application 165 wherein these application codes and additional directives may contain embedded browser directives to request third party advertising from one or more remote ad servers 130 for the purpose of displaying advertising on one or more clients browser 165 display windows. To insert the advertising the browser application software reads the embedded <HREF> directives from the program code and responds with a URL request through the router 155 modem 150 and Internet 1740 with the request ending at its final destination ad server 130. The ad server 130 responds to the request 1730 with delivery of the requested data and images files to the modem 150 and router 155 with a final return destination of the client computer 160. Once the ad image and information request is answered by the ad server 130 and returned to the client 160 a final interpretation and display of the ad by the browser 165 is accomplished. The browser then uses the HTML or XML program code to determine where within the web-page to place the ad and how to write, run and ultimately display the advertising images in the web browsers 165 web-page displays. Thus, the prior art illustrated by FIG. 1 shows the typical prior art method to deliver advertising from a third party ad server into common web pages where all units communicate over open Internet as know to one knowledgeable in the art.

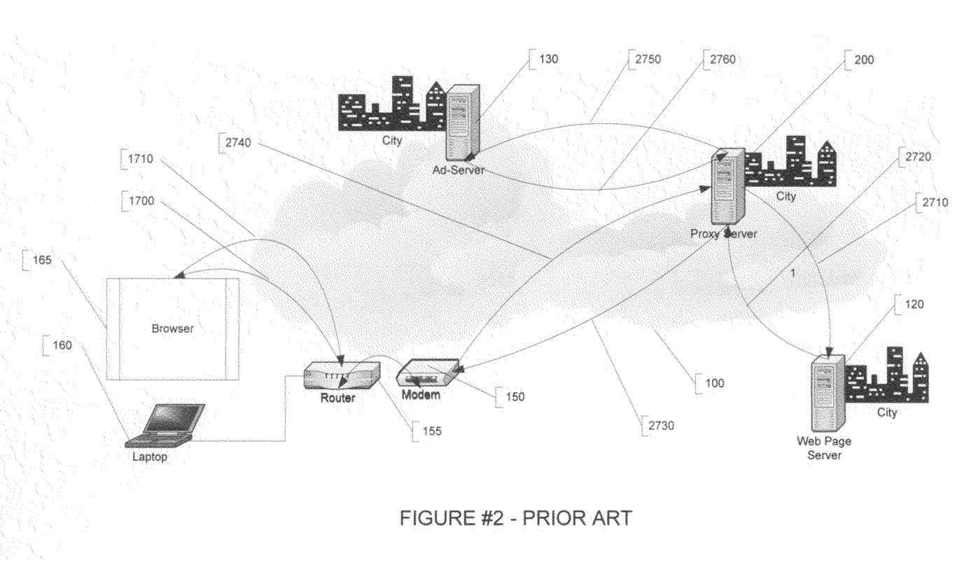

The illustration of FIG. 2 shows the addition of remote proxy severs 200 as an alternate method according to the prior art to place advertisements as banners, pop-ups, pop-under, sidebars, pre-authorization or post authorization pages into the client computers as known to one familiar with the prior art. ISP's or third party advertiser networks who control the all the HTTP Internet request data coming from or going to individual client computing devices typically use this data proxy method according to the prior art. Most wireless access points that use advertising revenues to pay for the cost of free wireless delivery use the prior art remote proxy model to inject advertising into client browsers.

Referring to FIG. 2 the process of advertising is similar to that illustrated in FIG. 1; the Browser requests a web-page from the web server 120. Only, instead of direct access the request 1710 to the router 155 is redirected by the router's IP routing acting as a gateway and redirecting the request first to the remote proxy server 200 instead of placing the original browser request to route to the web-page request to the web-page server 120. In this prior art embodiment all traffic from the modem 155 is routed first to the proxy server 200 and redirected 2710 to the web-page server 120 over Internet 100. Requested web-pages from the web-page server 120 are returned 2720 to the proxy server 200 for modification with additional scripts or hypertext as necessary to embed advertising. In the remote proxy implementation of the prior art the proxy server 200 returns the modified web-page 2730 over Internet 100 to the modem 150 and the router 155 delivers 1700 the modified web-page information to the client computing device 160 to the browser application 165. Based on browser interpretation of the modifications made, the browser requests 1710 additional data and or images from the ad server 130 in order to complete the process. In the prior art ad server request 1710 will again be directed 2740 to the proxy server 200 since the router 155 routes all HTTP data first to the proxy server 200 for redirection to alternate web-servers. The proxy server 200 forwards the ad image data requests 2750 to the ad server 130 which replies to the request 2760 through the proxy 200 over Internet 2730 to the modem 150 router 155 and client computer 160 for final interpretation and display by the browser application 165 software. Thus, the remote proxy server 200 has control of the web-page requests and can re-direct additional content or advertisements into the client browser 165 at any time. This prior art method is disadvantaged due to slower transport of data, requirements to send data from multiple locations through a single proxy point and security liability of sending and interpreting private user data prior to sending such information off to the original requested web-server. In some embodiments of the prior art the proxy server 200 and the ad server 130 may be the same server. Typically, remote proxy servers handle a plethora of URL requests from multiple locations slowing down Internet access for the original client requests. In addition, prior art proxy servers do not have the ability to inject ads in place of third party ads and are limited to using advertising methods as known to one knowledgeable in the art. Thus it is desirable to provide a scalable system that does not force user data through a central location and a system that scales linearly and minimizes cost by eliminating additional data-center bandwidth by injecting ad objects directly and locally at the networks edge and without modification to browser application code or the client computing devices software or code that is originally delivered from the web-page server.

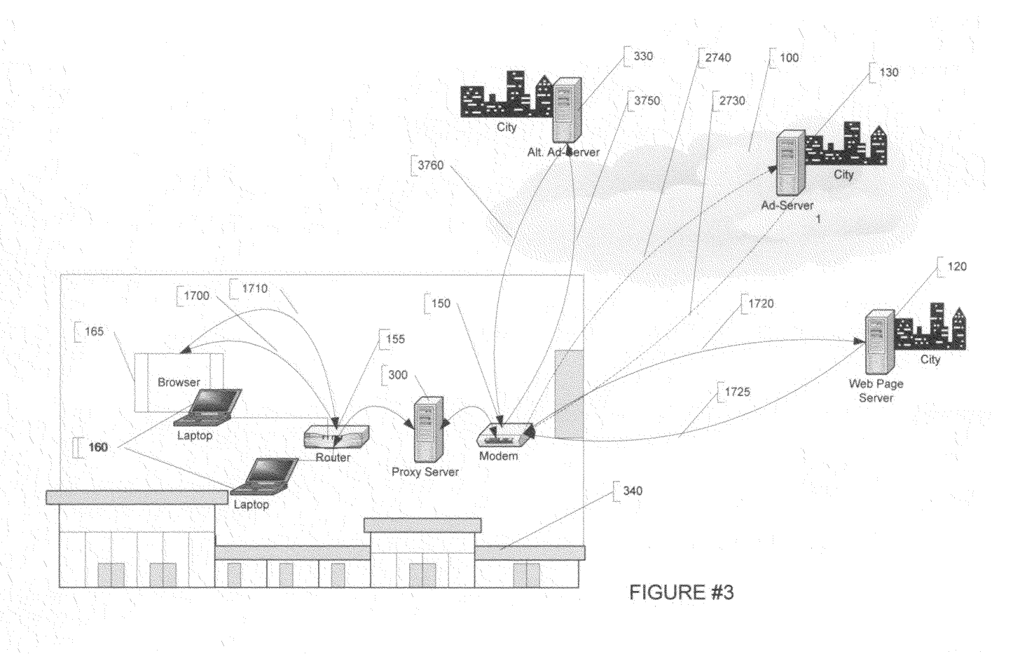

FIG. 3 represents one embodiment of the present invention using a local proxy server 300 or hardware appliance to manipulate the replacement of image and data objects requested by one or more Internet browser applications 165 running on one or more client 160 computers. Typically, client computers 160 are located within same proximity of the local proxy server 300. Image or data objects from the Internet 100 are transferred through one or more local modems 150 or in alternate embodiments various modem/router combinations. In some alternate embodiments of the present invention the modem 150, router 155 and proxy server 300 may be combined into a single device as integration and cost reduction process. In one embodiment of the local proxy configuration, data from the Internet 100 is routed from the modem 150 to one or more ports of the local proxy server 300. The local proxy server 300 may have one or more ports connected to one or more routers 155. In alternate embodiments, not illustrated herein, the Proxy server may only have a single port connected to the LAN port of a wireless or wired router. In the preferred embodiment, the router 155 is a wireless router connecting to wireless receivers located at or within the client computers 160. In the preferred embodiment the preferred wireless protocol is Wi-Fi or any of the 802.x standards. In alternate embodiments the interface, wireless or wired, can be any transport mechanism, specification or standard used to connect Internet information to client devices. In addition, alternate client devices may include Portable PCs, notebooks, mobile phone devices, GPS devices, PDA devices or any device capable of running Internet browser application software or firmware. One or more wireless enabled zones 340, sometimes referred to as “Hotspots” or “Access Points” enable wireless or wired connection to one or more client computers 160. Examples of Internet access points (AP zones) that are wired include hotels, offices, and apartments and homes. Thus, for this embodiment the term “wireless zone”, “hotspot” or “access point” implies an Internet access point (AP) 340 area. Wherein AP's are provided for use by private entities for public access whether provided for free or as a paid service.

Referring again to FIG. 3, pages from Web servers 120 are served up on demand by web-page requests coming from one or more web clients 160 some of which are located in public free or pay for service Internet access points (AP's) or wireless zones. Wireless zones 340 may use a plethora of ways to connect client computers 160 to the Internet 100. Most common is the use of 802.11x Wi-Fi wireless where “x” represents different versions of the 802.11 wireless standard known to one knowledgably in the art. In alternate embodiments the wireless transport mechanism may be provided by the cellular network, Wi-Max, LTE or other proprietary standards provided by the wireless carries also known to one knowledgeable in the art. In the preferred embodiment the proxy server 300 is used to “filter” and “substitute” data on the fly as data traverses between the modem 150 and the router 155. In alternate embodiments the proxy server may be implemented in software running internally in the device router or Modem router. Data objects from web page servers 120 may be recognized and categorized by the local proxy 300 using filter algorithms to identify priority objects that are targets for substitution by alternate web object servers 330. In addition, source images may be cached locally by the local proxy 300 and severed directly to the browser application software without the need to traverse through the modem. Caching of advertisements increased the speed of web page access by eliminating the time delay of objects delivered from one or more remote ad servers 130. In the preferred embodiment priority objects identified by the local proxy server 300 are advertisements used to promote Internet Marketing of goods and services. In alternate embodiments such objects may include other forms of communication or may provide other content such as local emergency broadcasting information, weather information, or any information that takes priority to the standard advertising objects that are normally delivered to the client browser. FIG. 3 illustrates the use of an ad server 130 to represent such objects delivered to client browsers.

Again referring to FIG. 3 the process steps for alternate object substitution can be illustrated. One or more users located within the access point area 340 will first request a web-page from one or more web-sites 120 identified by the Universal Resource Locator (URL) 1720 that points to a Domain Name Server (DNS) used to assign a location name to a physical IP address thus redirecting the request to the proper web server 120 such that the requested page of source code 1725 may be returned. In the preferred embodiment requested data does not need to traverse a remote proxy server 200 as illustrated in FIG. 2 of the prior art. Instead, in the preferred embodiment requested web-page information comes directly from one or more web page servers 120 and transferred 1725 directly to the modem 150, local proxy server 300, and router 155 and to the client computing device 160 for interpretation by the client computing devices Internet browser application software. Once the browser receives the requested page source from the web-server 120 it will interpret the HTTP protocol and source data for instructions to request additional images and other content from one or more remote content or third party ad network servers. In the prior art as illustrated in previous discussion of FIGS. 1 and 2 the remote third party ad network server 130 would return data objects 2730 based on the URL request 2740 initiated by the client browser application (illustrated by the dotted lines in FIG. 3.) In the preferred embodiment of the present invention the Proxy 300 preferably filters and identifies said objects using various filter algorithms so that certain object requests are not delivered to the ad-server 130 directly. Instead they are retrieved from one or more alternate ad network servers 330. This is accomplished by means of HTTP interpretation filters running locally within the proxy 300. Interpretation filters force a redirection of the requested original URL's 2730 such that information that would normally be requested from the ad server 130 is requested 3750 and redirected 3760 by one or more alternate ad servers 330. Requested advertising objects or content dimensions 3760 may be served with similar formats of size and display qualifications (tokens) of the original objects. By returning similar objects from the alternate ad network server 3760 the present invention does not require advertisements or content to “pop-up” or reposition the browser page for “tool-bar” advertising as known to one knowledgeable in the art. Thus, the web page display orientation and quality remain very high without any noticeable difference to the original web page layout. In the preferred embodiment the proxy server 300 filters ad network domain requests 1710 from the browser application 165 and blocks those requests then substitutes the original requests with one or more alternate domain requests. In this preferred embodiment the proxy server acts as a firewall inhibiting certain third party ad servers 130 from access and display of advertising on the local area network of the wireless access area 340. In the preferred embodiment the original inbound web page information is not altered protecting the original copy-right (if any) of the original page content. In some alternate embodiments the proxy server 300 may alter the inbound web-page programming information by injecting one or more alternate ad network 330 server addresses directly into the incoming 1725 web page programming prior to the client browsers 165 inspection and subsequent additional web page data object requests. In the alternate embodiment the browser application will not be directed to request additional objects from the original ad network 130 server and instead will request objects from the alternate 330 ad network server for final assembly and display into the browsers display window. In other alternate embodiments the proxy server 300 located within the AP zone 340 may be embedded into one or more of the other devices such as the modem 150, router 155 or alternately into the client 160 computing device or client computing devices browser application 165 directly.

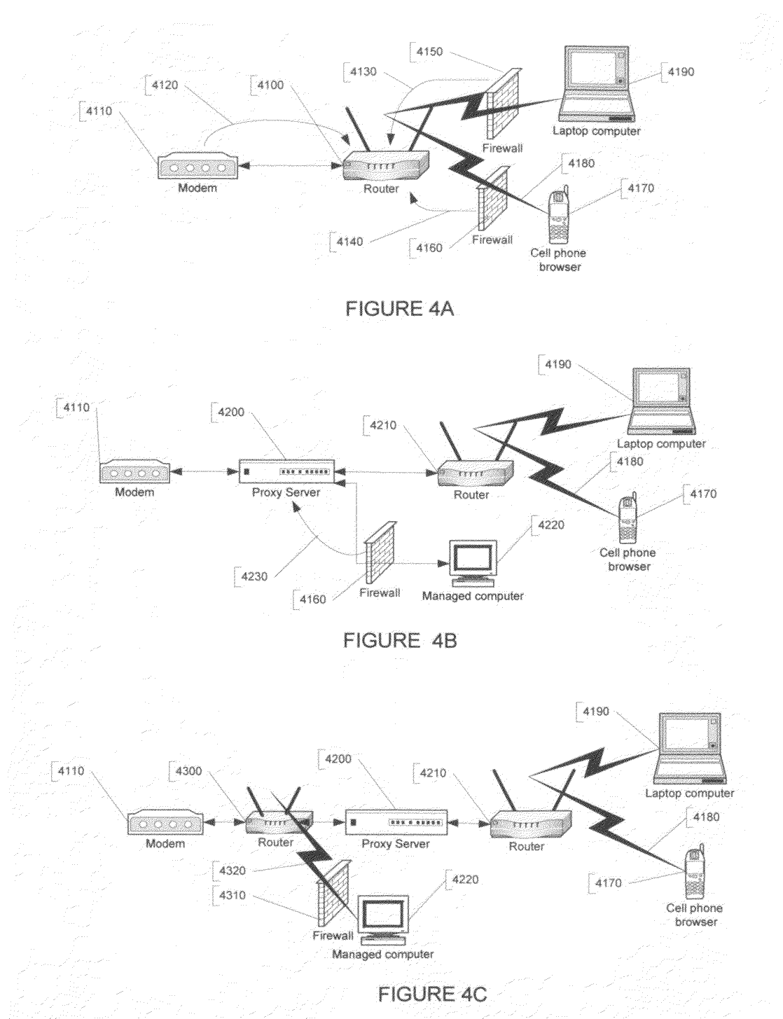

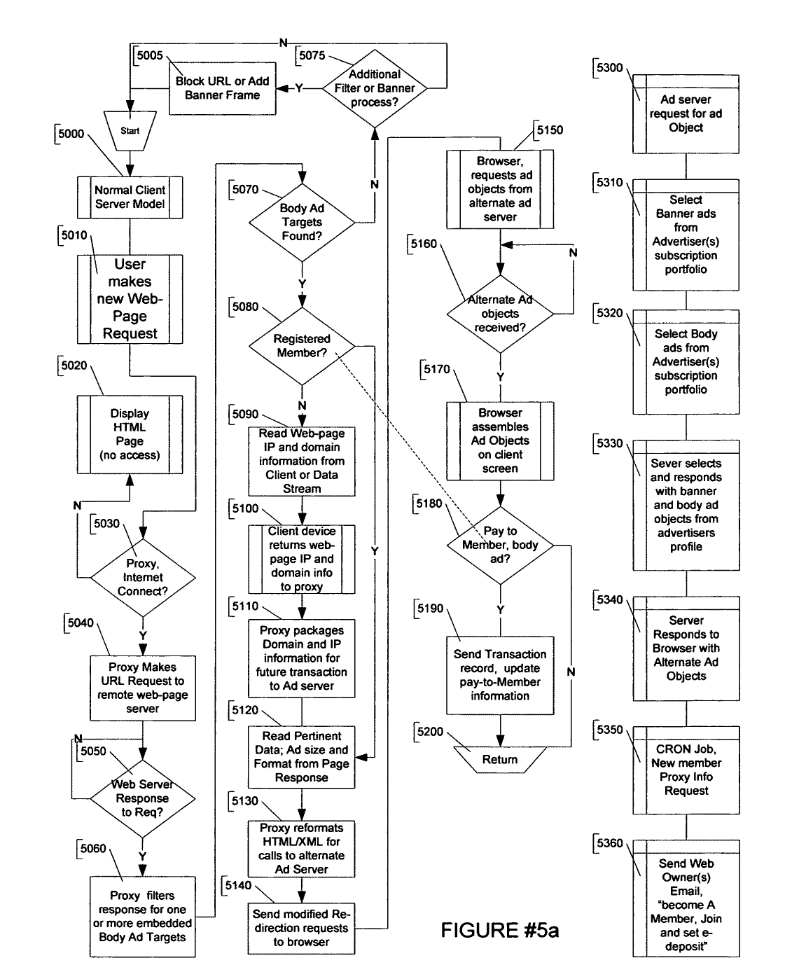

FIGS. 4a, 4b, and 4c illustrate various ways the system of the present invention may be integrated into alternate internet access point 340 areas. FIG. 4a illustrates the preferred embodiment whereby the local proxy server 300, gateway and wireless transmitter are integrated combining the router, access gateway and proxy device 4100 within the same system appliance. In this embodiment the WAN modem 4110 connects directly to the proxy device 4100 which becomes the router, firewall and gateway access device along with the data and HTTP protocol interpreter and modification device. This device 4100 preferably also integrates one or more wireless radio transmitters and receivers for wireless connection to cell phones 4170 or mobile Internet 4190 devices. This device preferably communicates to clients 4190 4170 directly and may also provide security and firewall capability 4150 4160 as well. In this embodiment the proxy device 4100 communicates and routes all information 4120 4130 4140 within one or more Internet access point 340 locations. FIG. 4b shows an alternate embodiment of the present invention wherein the Proxy server 4200 is separated from the routing and wireless transmitting device 4210. In this embodiment the proxy serer 4200 may contain the gateway functionality for firewall and connectivity capability as well as the HTTP interpretation and modification filters of the present invention. FIG. 4c shows yet another alternate embodiment of the present invention wherein an additional private router 4300 is introduced for locations that want to isolate a private subnet 4320 from the public wireless subnet 4180. Use of a private subnet keeps injected advertising and third party from being shown on the private subnet. In this alternate embodiment additional security separates the managed computer system 4220 from access by the open “free wireless” sub-net provided by the wireless router 4210.

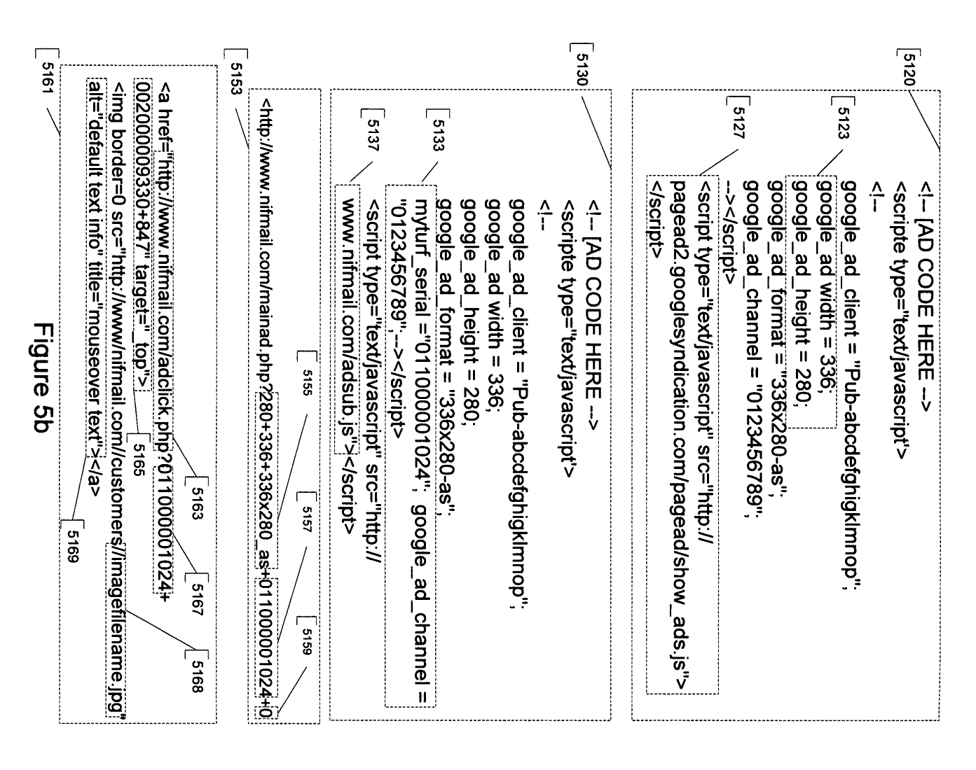

The preferred embodiment of the present invention uses many different programming languages and protocols to accomplish the task of alternate object substitution within a client browser application running in a local AP zone. FIGS. 5a & 5b illustrate one of many possible process flows used to implement the preferred embodiment of the present invention. The implementation of the preferred embodiment as illustrated in the flowchart of FIG. 5a is that of a client-server 5000 model as known in the present art and described previously in FIGS. 1-4 whereby, the browser application running on one or more client devices initiates the process by making a web page request 5010 typically via the search bar in the form of “http://{URL LINK address?directives}”. This link contains the domain name and specific page or program requests to access from one or more web servers for page delivery information to the browser application. The local proxy server receives the request which, if the proxy has Connection to the Internet 5030, will forward the original page requests 5040 to the remote web server notifying the server to start sending web page data to the requesting client. If the proxy has not established connection 5020 due to loss of Internet connectivity, or by request of the AP zone owners to limit time of use or hours of operation, the proxy may forward one or more notification pages 5020 stating the reason for no Internet connectivity. Once the client browser has forwarded the request and the proxy has determined there is Internet connectivity the process continues with a response 5050 from the remote web-server answering the client browser's URL request for web page information. To begin the process according to one embodiment of the current invention the local proxy server will first examine one or more of the web-server responses and filter them 5060. In the present invention “body-ads” are defined as “in-page” or “page-ads” as known to someone knowledgeable in the art of Internet advertising. Body-ads have specific predetermined size (ad resolution) and location (browser display position) information. In the preferred embodiment one such filter configuration determines if the web-server responses include additional URL requests for advertisements that are typically served up from remotely located ad web servers. These requests are typically in HTML or XML format with corresponding information such as Ad Type, Ad Size, Ad display position and possible various other display parameters (tokens) and at least one or more ad (data-object) URL address. Requests may include additional information pertaining to the domain owner of the web-site from which the original web-page is sourced. For example, body-ad targets may have the HTML format as illustrated in FIG. 5b wherein the original web-page code segment 5120 can be compared to the altered code segment 5130 used for alternate ad substitution into the client browsers display window. Again referring to FIG. 5b it is important to the operation of body ad substation of the present invention that the size or resolution of the original image 5123 along with the proxy unit serial number 5133 be echoed back to the alternate ad server by the newly injected JavaScript routine 5137 that is substituted for the original JavaScript 5127 by at least one or more local proxy server devices 300. Referring again to FIG. 5a, in one embodiment the proxy sends the modified information (detailed in FIG. 5b 5137) to the browser application 5140. This modified information is transparent for the rest of the body-ad or banner-ad injection process of the present invention. The injection process then continues 5150 between the client browser application and one or more alternate ad servers. Once the browser application receives the first requested information the process continues with additional requests to complete the web-page display of one or more alternate body-ads or banner-ad injection by requesting advertising objects again from the alternate ad server. Once the JavaScript program (FIG. 5b—5137) is received 5160 by the browser from the alternate ad server, the browser interprets the code in preparation for access of the alternate ad objects. This JavaScript is typically cached on the Client device such that after the first body-ad is completed the JavaScript source is no longer read from the alternate ad server a caching technique known to one knowledgeable in the art. Once again referring to the illustration of FIG. 5b, the resulting request for ad objects 5153 contains the alternate ad server URL address and file extension for execution by the alternate ad server on delivery, the ad size and resolution 5155, the unit serial number 5157 (indicating the internet access point location) and a token field 5159 indicating the number of body-ads on a particular page. In the preferred embodiment the token 5159 is used by the ad server to determine how to handle more than a single body ad per web page. This token is necessary to allow additional advertiser's to display more alternate ads when more than a single alternate ad is substituted on a single web-page. In the present invention, to derive this token a JavaScript or equivalent script sets a temporary cookie indicating the encounter of a first body ad target. For every body ad encountered the token may be updated indicating that more than a single body ad will be present on a single web-page. The client cookie is then cleared on every new page request. Thus, in the preferred embodiment the browser application may make at least one or more requests to at least one alternate ad servers for display of at least one advertisement within one or more client browser displayed web-pages. Embedded in the request is all the necessary information for the ad server to properly select and deliver alternate advertisements. Once again referring to FIG. 5b in the present example, the alternate ad server delivers the final HTML command stream 5161 to the browser application. Within this command stream are the click-through URL reference address and server file URL and file name extension (run file on click) 5163, the unit serial number 5167 (where the click originates), the ad identification number 5165 and ad-offset number for indexing into the alternate ad servers image database, the source-image file name and extension type, the URL address 5168 that points to one or more alternate ad servers, and the default alternate text 5169 and mouse-over text. Also included in the HTML command stream there may be various format commands used locally by the client browser to place and format the images for display presentation. In alternate embodiments these command streams may be encrypted for security and may take on many different formats such as JPEG, GIFF, animated GIF, FLASH animation or encapsulated/streaming video ads. This HTML/XML response stream from one or more alternate ad servers of the present invention is interpreted by the browser application which, instructs the browser to read the actual source image information, or deliver information such as the “hover” or “click-through” and may also included the time spent in certain areas as known to those knowledgeable in the art. In addition, this invention may alternatively contain content and other programming that is injected into web page display areas of at least one or more browser display windows. Also in alternate embodiments the plethora of internet ad networks implies that there are many techniques to display Internet advertising in common browsers. Each of the ad networks may take on a different ad “style” or “format” from the example illustrated in FIG. 5b, but all can be applied with intent as taught in the present invention. It is assumed that one knowledgeable in the art along with the system and method of the present invention can determine the necessary programming to build the system for third party in-page body-ad substitutions for any number of third party ad networks.

Again referring to FIG. 5a, if the local proxy server determines there are no data objects for alternate substitution 5070 the original requested information may be filtered for additional content 5075 to be removed or added based on the specific proxy capabilities and user configuration. In most cases one or more banner (tool-bar) advertisements may be displayed as alternate frames 5005 and presented to the browser application for insertion preferably at the top or bottom of the web page. In alternate embodiments the configuration firmware can place banner ads or injected frame objects in alternate locations for display or, may present the injected objects as float-over or float under windows such as pop-up or pop-under objects as known to one knowledgeable in the art. In another alternate embodiment the local proxy filters may be used to capture advertiser's keywords and replace the web programming for normal text known to one in the art as interstitial advertisements. The programming for interstitial ads may use the same system and method of the present invention but does require changes to the web-page commands to make use of the present invention for ad display into standard client browsers.

Again referring to process of FIG. 5a during the process of the preferred embodiment when possible page locations (body Ad targets) are found 5070 for ad injection it may be important to log the original domain or web-page owner for possible future financial compensation. In the prior art, the “owner” is responsible for addition of the ad network's widget (code snippet) into one or more of the web-pages on the owners domain. These widgets typically instantiate a JavaScript routine to allow third party ad networks to insert various advertising dynamically into the client browsers page display window. In one embodiment the “domain owner” can be identified 5080 for compensation based on previous registration with the alternate ad network company. In order to determine who is compensated, information from the original response may be used to determine the Domain 5090 name based on various owner registration information. Process steps 5090, 5100, 5110, 5180, 5190 and 5200 are illustrated to teach the method for owner or domain name recognition in order to make compensation payments. In one embodiment the local proxy server may filter the URL history logs to extract the original web-site domain and post process a reverse DNS lookup to determine the actual owner of the web page. This session information may be obtained from the client 5090 by request through one or more methods as known to one knowledgeable in the art. In an alternate embodiment wherein the owners must register for compensation, the previously look-up owner information may be compared to the web-domain owners registration database to determine payment information. This compensation process may be completed post ad insertion time or in non-real-time to the operation of serving ads. Alternate embodiments may also be used to avoid any copyright infringement of the present example by checking for web page copyright notification prior to interpretation and replacement of programming by the one or more local proxy devices. In this alternate embodiment, a government issued copyright database may be used to determine domain sites that have registered copyrights for particular content. To enable this alternate method a “List” of copyright sites must be built and searched to disable ad substitution when the original web page software codes are modified. These lists of copy-right protected domains must be compared to the incoming web-site domains in real-time by the local proxy server. In another embodiment there may be no compensation paid because all content from the Internet is presented in a “closed-circuit” environment whereby retransmission of the content into one or more private Local Area Networks is preformed. The alternate embodiment of a closed circuit approach has not yet been tested by the market for determination of validity with common Internet laws, but technically stands as a valid method and shows additional justification for the novelty present invention disclosure. In most cases, Internet information is repurposed for many other reasons other than that disclosed herein. In one embodiment as illustrated in the example of FIGS. 5a and 5b the HTML/XML source code information sent to the client browser 5140 is modified prior to the browser interpretation for additional data requests. Alternatively, in the preferred embodiment data requests may be sent directly to the remote ad server by the proxy server without prior interpretation by the client browser or any HTML/XML source code modifications. In the preferred embodiment of the present invention step 5140 of FIG. 5a is replaced by sending the original web-page server response directly to the browser un-altered. The browser then requests information from the third party ad networks in normal fashion. At this point the local proxy unit blocks the third party ad network requests thus stopping the flow of requested third party ads. The requests are modified and redirected to the alternate ad server thus requesting alternate body-ad images to be served to the client browser application. Thus, by using this preferred method, the browser then requests alternate ad objects from the remote alternate ad web server 5150 and when received 5160 are passed through the local proxy server to the browser application for assembly 5170 to the client display.

As previously outlined in FIG. 3, the method of the preferred embodiment begins with various requests originating from the client browser 165, then modified by the local proxy server 300. The process ends with various responses from the alternate ad server 330 to these requests. Alternate ad servers 330 are used to serve ads 3760 back to the client computing device 160 for display by the client browser application 165.

Now referring again to FIG. 5a we focus on the process performed by one or more alternate ad servers 330 typically from a remote location and used to actually serve ad images. In addition, other parameters are used for tracking and reporting with respect to ad views and click through user activity. Starting with process step 5300 the alternate ad server pre-parses the various requests from the local proxy server. Referring to FIG. 5b, the preferred requests are generated from the local proxy server by blocking the third party ad network URL and instead making a request to one or more alternate ad servers. The first request consists of the URL address pointing to one or more JavaScript modules 5137 located on at least one alternate ad server. This JavaScript module is delivered back to the client browser for interpretation. It contains an embedded URL address pointing to one or more JavaScript modules. The alternate ad server responds back to the client browser application by sending one or more JavaScript modules each of which embed additional parameters for further browser processing. Included in the response from the alternate ad server are browser requests to determine the alternate ad display resolution 5155 and the unit serial number 5157 of the local proxy server. In some embodiments the original ad network type 5159 is also included. At least one or more client browsers receive and process the JavaScript in order to formulate the next ad request from the alternate server. This request also returns parameters after needed by the alternate ad server to determine which advertisements are to be displayed on the client system. The client browser 165 after interpretation of the JavaScript 5300 and the determination of ad image size and original ad network returns 5153 all the necessary information for processing by the alternate ad server along with the file name used to start the process of determining which ad will be sourced for eventual client browser page display. Once the alternate ad server receives the request it selects only one of many ad images and formats 5310 to respond with. On the alternate ad server the ad selection process starts by finding all the ads that are currently active and published into the location indicated by the unit serial number 5133. Then based on fairness algorithms and client account status, selects the next advertiser account with active advertising subscriptions and further selects one ad based on an estimated match of image width and height from the selected advertisers account. There are many algorithms used to determine which advertisers and which ads are displayed in what order. In one alternate embodiment, ad images that are transported to the client proxy server are cached into either the client's browser cache or the local proxy server cache memory in order to speed-up the ad delivery process and effectively increase the speed of page rendering completion at the client. JavaScript modules may be programmed to rotate images between ad subscriptions from different advertisers on a ad by ad looping bases. By cycling the ads, advertisers receive more coverage for pages where users surfing habits are less than sticky. Once the alternate ad server 5310 has selected one of many alternate ad images 5320 from one of many advertisers the alternate ad server responds 5340 with the image selection URL address along with a number of other embedded parameters. The process of FIG. 5a determines when advertisements should be injected based on particular accounts and the ability to inject into non copyright or closed circuit Local area Networks. In the case of body ad substitution, the browser JavaScript application substitutes an additional reference link forcing the browser to report when the user clicks on alternate ad images for further information about the product or service offering.

Again referring to FIG. 5a, as known to someone knowledgeable in the art, a CRON job (scheduled upload from the Proxy) may be used 5350 to send domain and user information back to the central server for further processing. If owners are identified as registered owners the system will deposit the appropriate consideration amount to the web-owners site in preparation for future payment. In some cases web authors or domain sites do not contain user's addresses 5360. In these situations, the process sends out an automated email notifying the domain holder to sign up for payment. The email is sent using a reverse look up technique as known to one knowledgeable in the art.

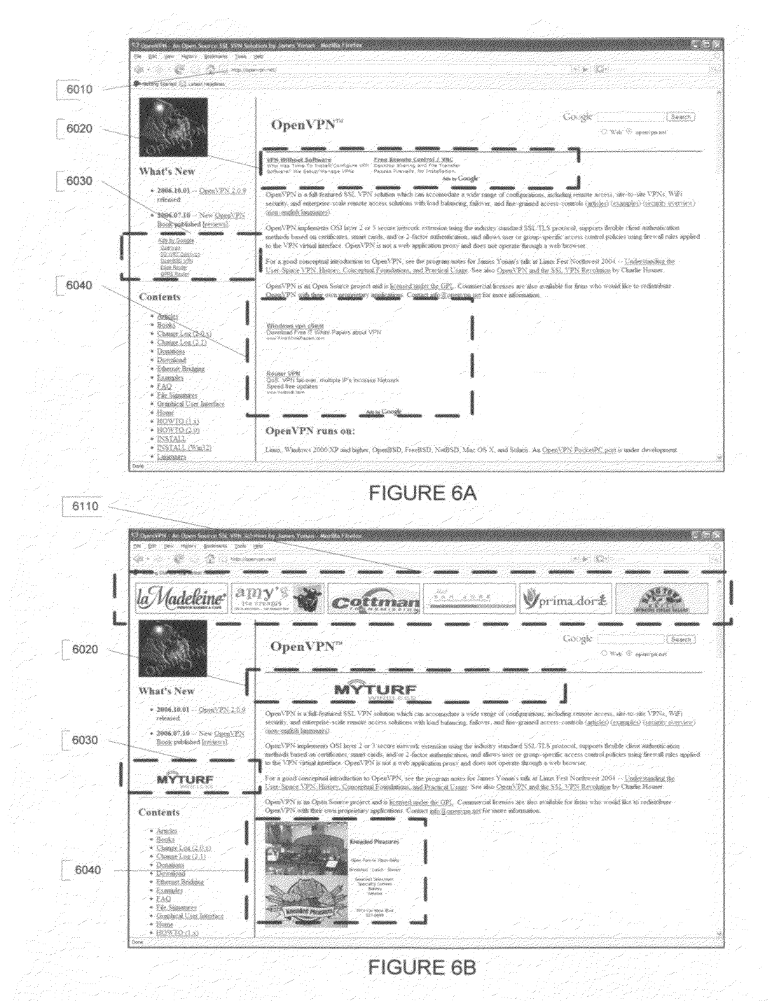

FIG. 6a depicts a possible web page rendered on the client display by a possible browser application. The example of FIG. 6a illustrates both banner advertisements 6110 and three area's of the page 6020 6030 6040 targeted for in-page ads or body ad replacements. Targets are determined by the local proxy filters wherein advertiser's ad server URL addresses match a list of qualified addresses programmed into the local proxy server. FIG. 6b illustrates the results of the banner 6110 and body ad 6020 6030 6040 substitution process according to the preferred embodiment of the present invention.

Again referring to FIG. 6b the sizes and positions of the alternate body ads 6020 6030 6040 are the same as those sizes and positions that the original ads would assume had the original ads been rendered onto the display by the browser application. All attributes such as click through URL's, alternate text and mouse over text are also changed to reflect the proper information as intended by the advertiser. Thus, according to the present invention the process of body ad substitution can be completed on the client browser without modifications to any of the client computing device software including browser code, the browser set-up, or browser control software.

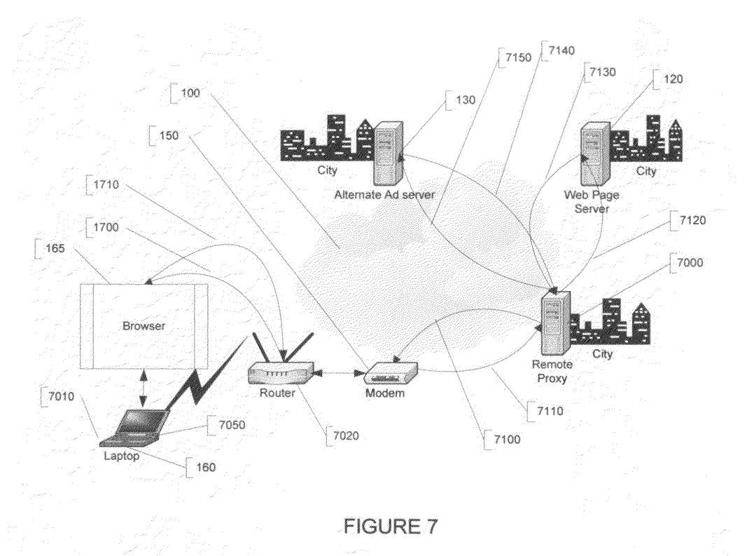

In alternate embodiments as that illustrated in FIG. 7 it is desirable to move the process or filtering the ad network URL address of f the local proxy and over to a remote proxy server. The remote proxy server may filter a plethora of locations and client browser applications. This alternate method for some situations may not be as desirable due to increased bandwidth costs. This increase in bandwidth is because all port 80 Internet requests from the plethora of internet devices must first be routed to the remote proxy for examination and possible modification of the HTTP protocol traffic. Although, in some instances sharing a remote proxy server across many HTTP streams may be cost effective because of reduced service costs by minimization of the network edge local proxy server units. Instead, this alternate embodiment only requires that the router have the ability to HTTP redirect to one or more remote proxy servers. This alternate embodiment is illustrated in FIG. 7 where the majority of the data flow 7100 7110 and process is similar to that of the preferred embodiment of local proxy servers except the local proxy has been moved to an external hosting site 7000 or co-location center. FIG. 7 illustrates three remote web servers and a local site where the client device 7010 is connected to one or more routers 7020 through wireless or wired network connections and connects to the internet through one or more modems 150 giving Internet network connectivity to the private local area network (LAN) 1710 1700 devices 7010. Within the client device is one or more browser 165 applications used to interrupt the Internet protocol stream and render information and images on the client devices 7010 display. The WAN modem 150 communicates 7110 7100 between the remote proxy servers first with a URL request 7110 typically to display a web-sites home page. This request is communicated 7120 7130 to one or more web-servers 120 typically with one or more requests for commands and data required to build one or more home index pages. The web-server 120 responds with the page request 7130 to the proxy 7000 which forwards the HTML or XML information back to the browser application 165 through typical TCP/HTTP protocols for display 7010 on the client device. During the transport through the remote proxy 7000 this information may be altered to redirect third party ad network requests to and alternate ad server 130. In the preferred embodiment the remote proxy 7000 filters and blocks certain ad network URL's and substitutes URL addresses that point to the alternate ad server 130. Preferably the remote proxy may filter information for advertisers URL references, advertisement dimensions and types or other information in real time with the acquired HTTP Internet data stream 7110. As the web-page server 120 returns the initial command page source code (for ad networks this is typically contains one or more JavaScript modules used by the ad networks for display advertising) to the browser application, the browser prepares another request for ad objects from the third party ad server (not shown in FIG. 7). The browser request 7110 is received by the remote proxy 7000 and processed for blocking third party URL requests and instead embeds the URL pointing to one or more alternate ad servers 130 with embedded parameters as required to finish out the body-ad substitution process. In alternate embodiments, before the Internet Protocol stream 7130 is sent back to the client browser application 165 the remote proxy can substitute third party ad server URL information and parameters with information that will force the browser to issue requests not from the original third party ad server but from the alternate ad server 130 according to the present invention. In this alternate form of the embodiment these substitutions take place on the remote proxy 7000 server. Now, in reference to the preferred embodiment, the first substitution may be for one or more banner ads 6110 (FIG. 6) whereby a separate frame is added next to the top <body> statement and is subsequently used for multiple ad injections into that banner (tool-bar). The frame has one or more external references used to request ads for display into the banner advertisement bar typically located on the top of the browser page. In alternate embodiments the banner bar may be anywhere on the display and not necessarily at the top of the page as known to one knowledgeable in the art. The second substitution occurs when the remote proxy server 7000 detects an “in-page” ad request herein known as a “body ad” URL request. In the preferred embodiment one or more components of the URL requested 7150 is altered by the proxy 7000 to one or more alternate components sending said alternate components in a request 7150 to the alternate ad server 130 instead of the third party ad server as originally requested by the client browser. The altered browser parameter requests 7140 are relayed through the proxy server 7000 and onto the client computing device 7010. This stream 7100 instructs the client browser 165 to request information for images that will be inserted as body-ads into the browser application display window that are received from one or more alternate servers 130. The alternate request 7150 has a response 7140 containing the information needed to display the alternate advertisement or information on the client 7110 display. Not shown in FIG. 7 is a direct path between the alternate ad server and the client browser application. In such alternate embodiments some of the network routing may make it possible to avoid sending image data and parameters back through the remote proxy server as known to one knowledgeable in the art.

In the preferred embodiment the proxy server 7000 of FIG. 7 would be located within the premises of the Local Area Network making it a local proxy server as disclosed herein. This local proxy server serves the local client browsers the corrected information to allow body-ad substitutions. The reasons for local location of the proxy server are mostly for economical and scalability and allow increased performance especially when alternate advertisements are cached locally within the premises. In the preferred embodiment proxy server 7000 is integrated into the router 7020 or modem 150. When the proxy capability is embedded into the router device the installation of the system is simply the same or nearly the same as that of a standard router. This allows scalability and lowers the cost of installation.

The present invention greatly enhances the ease of use and reduces the complications of embedding alternate advertisements and information into mobile computing devices located at the edge of the wide area network. The network appliance device is typically placed on the Local area network just prior to the Wide Area Network interface or mail server. The primary function for the present invention is to allow tracking, embed propaganda or branding and inject advertising directly to said client devices located in one or more areas within proximity to the point of sale of goods and services. The invention allows encrypted watermarks to be hidden for tracking purposes dramatically increasing the ability to track information and to determine and respond with targeted information directly to the point of sale. The present invention adds a new dimension and is a novel distribution methodology for discrimination of propaganda, advertisements, news, security product branding. The ability to automatically update messages from a remote server allows for dynamic and immediate messaging which puts another dimension on conventional datagram distribution.

Although the present invention has been described in considerable detail with reference to certain preferred versions thereof, other versions and variations are possible and contemplated. For example, the present invention has been illustrated in an embedded network device placed in serial between the router, switch or hub the Wide area network modem or even directly into the client browser, but is applicable to almost any computing device on the Local Area Network in a variety of configurations. In one embodiment the present invention may be programmed into a PC on the network where the PC performs the same method and process as the described herein. Moreover the filters in the preferred embodiment may be configured using any type of alternate filters to achieve the desired results of the invention. In another alternate embodiment a network device may be used to insert a proxy server address for redirection and further processing to achieve the same results as indicated herein. The present invention is advantageous in the area of network security where real-time passive monitoring is needed for specific message monitoring and filtering purposes. In some cases, other filters and rules may be used to discriminate other forms of pertinent data for modification, updating or logging. Finally, those skilled in the art should appreciate that they can readily use the disclosed conception and specific embodiments as a basis for designing or modifying other structures for providing the same purposes of the present invention without departing from the spirit and scope of the invention as defined by the appended claims.

1. A method of using one or more software applications in a client/server model running on one or more computing devices using standard network protocols for communication over one or more local or wide area networks, wherein;
at least one said software application proxies network traffic between at least one Internet server application and at least one client browser application, and wherein;
at least one said software application intercepts one or more client browser requests for first content delivery from one or more first Internet server applications, and wherein;
said software application indentifies pertinent information within said client browser requests, wherein;
said pertinent information is modified by substitution of one or more second URL addresses pointing to at least one second Internet server application, wherein;
said second URL address is used to request second content from said second Internet server application to satisfy at least one of said client browser requests, and wherein;
said client browser application receives said second content from said second Internet server application to satisfy all requirements of said first content request.

2. A method according to claim 1, wherein said software applications running on said computing devices identifies at least one said computing device unit serial number, and wherein said software application embeds said unit serial number into one or more requests sent to said second Internet server application for said identification and manipulation of said components of said second content.

3. A method according to claim 2, wherein at least one of said second Internet server applications delivers one or more instructions to one or more said client browser applications requesting one or more display resolution attributes of said requested first content from one or more said first Internet server applications, and wherein;
said display resolution attributes include the width and height parameters contained within said first content request by said client browser application.

4. A method according to claim 3, wherein at least one said second Internet application receives requested said display resolution attributes for the selection of a single display object, and wherein;
said single display object is selected from a plethora of digital images, animation scripts, digital video clips or other various content types under access control of one or more said second Internet applications, and wherein;
selection of said single display object by said second Internet applications closely resembles that of the actual width and height resolutions of the said display resolution attributes, wherein;
said selected single display object has width and height dimensions that are within a predetermined error margin or resolution range of said display resolution attributes.

5. A method according to claim 4, wherein said access for said single display object must be determined by one or more said second internet applications using at least said unit serial number, customer account information and said display resolution attributes to derive the access address of said single display object, and wherein;
said second Internet application stores said access address of said single display object into said second content and delivers said second content to satisfy said client browser applications request.

6. A method according to claim 5, wherein one or more said client browser applications transparently displays at least one said single display object as a component of said second content without visually altering other components normally displayed within one or more client browser display windows.

7. A method according to claim 1, wherein said second content from said second Internet server application used to satisfy said all requirements of said first content request other than standard browser plug-in modules such as JavaScript or Flash animation, does not require changes, modifications, or updates to either said client browser application, client computing device or said first Internet server applications.

8. A method according to claim 6, wherein said second content delivered to one or more said client browser applications includes one or more tokens, wherein;
first token pertains to the number of available display window targets for additional said second content that may be available within a single client browser page display, wherein;
said first token is incremented for each said available display window target found on a single web-page by client browser application, and wherein;
said first token is embedded into one or more requests sent to said second Internet application server for interpretation and deliver of additional said second content, and wherein;
Said first token is reset for each new client browser page request by said client browser application.

9. A method according to claim 1, wherein one or more domain name owners or one or more web-site owners may be compensated as a result of displaying said second content on one or more client computing devices, wherein;
Said first content request contains page request information, and wherein;
One or more universal resource locators contains the domain address pointing to one or more said first Internet server applications, and wherein;
Said URL address information is used to automatically perform one or more reverse lookup operations to acquire domain owner contact information, and wherein;
Said domain owner contact information is used for said compensation.

10. A method of using one or more software applications in a client/server model running on one or more computing devices using standard network protocols for communication over one or more local or wide area networks, wherein;
at least one said software application proxies network traffic between at least one Internet server application and at least one client browser application, and wherein;
at least one said software application intercepts one or more said Internet server application responses containing the first content delivery to one or more said client browser applications, and wherein;
said software application indentifies pertinent information within said Internet server response, wherein;
said pertinent information is modified by said software application by substitution of one or more second URL addresses pointing to at least one second Internet server application, wherein;
said second URL address is interpreted by said client browser application and used to request second content from said second Internet server application to satisfy at least one of said client browser requests, and wherein;
said client browser application receives said second content from said second Internet server application.

11. A method according to claim 10, wherein said software applications running on said computing devices identifies at least one said computing device unit serial number, and wherein said software application embeds said unit serial number into one or more requests sent to said second Internet server application for said identification and manipulation of said components of said second content.

12. A method according to claim 11, wherein at least one of said second Internet server applications delivers one or more instructions to one or more said client browser applications requesting one or more display resolution attributes of said requested first content from one or more said first Internet server applications, and wherein;
said display resolution attributes include the width and height parameters contained within said first content request by said client browser application.

13. A method according to claim 12, wherein at least one said second Internet application receives requested said display resolution attributes for the selection of a single display object, and wherein;
said single display object is selected from a plethora of digital images, animation scripts, digital video clips or other various content types under access control of one or more said second Internet applications, and wherein;
selection of said single display object by said second Internet applications closely resembles that of the actual width and height resolutions of the said display resolution attributes, wherein;
said selected single display object has width and height dimensions that are within a predetermined error margin or resolution range of said display resolution attributes.

14. A method according to claim 13, wherein said access for said single display object must be determined by one or more said second internet applications using at least said unit serial number, customer account information and said display resolution attributes to derive the access address of said single display object, and wherein;
said second Internet application stores said access address of said single display object into said second content and delivers said second content to satisfy said client browser applications request.

15. A method according to claim 14, wherein one or more said client browser applications transparently displays at least one said single display object as a component of said second content without visually altering other components normally displayed within one or more client browser display windows.
